(19) United States
(12) Patent Application Publication
(10) Pub. No.: US 2006/0076742 A1
(43) Pub. Date: Apr. 13, 2006

(54) Modular snowmobile ski

(75) Inventor: Wayne E. Scholl, Little Falls, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Northwoods Power Sports Distributors, Inc., Monticello, MN (US)

(21) Appl. No.: 11/243,430

(22) Filed: Oct. 4, 2005

Related U.S. Application Data
(60) Provisional application No. 60/617,916, filed on Oct. 12, 2004.

(51) Int. Cl. B62B 19/00

(52) U.S. Cl. 280/28

(57) ABSTRACT

A modular snowmobile ski is provided with a base that has longitudinally extending retainers, as shown, slots, or longitudinally extending slidable engaging projections that will accept ribs, keels, and the like with complimentary retainers. Various types of center keels or ribs can be provided for changing the aggressiveness of the ski, that is, the amount the ski will bite into the snow. Stabilizing or tracking ribs also can be provided along the ski edges. The base of the ski is provided with retainers that will hold side extensions in place on the ski when desired.

### CROSS-REFERENCE TO RELATED APPLICATION

The present application is based on and claims the benefit of U.S. provisional patent application Ser. No. 60/617,916, filed Oct. 12, 2004, the content of which is hereby incorporated by reference in its entirety.

### BACKGROUND OF THE INVENTION

The present invention relates to a snowmobile ski that permits adding ribs that can form a keel, side ribs and snow deflectors, and other modules to tune the ski for use, and make it adaptable for trail riding, racing, and general use. The modules are added to the sides and/or the underside of the ski.

Snowmobile skis generally have formed keels that are molded in place on the bottom of the ski. Ribs projecting from the bottom along the sides of the ski are also known, when molded or formed in place. Most snowmobile skis are molded from synthetic materials. The control offered by the various keel shapes available is not suitable for all uses. A rider may have different desires as far as the ability to control the snowmobile, and if any changes are to be made to improve control, the changes usually require replacing an entire ski.

### SUMMARY OF THE INVENTION

The present invention relates to a modular snowmobile ski that has modular replaceable components, particularly for the bottom side of the ski. A replaceable center keel permits changing the aggressiveness or bite of the keel easily and simply. Also, modular ribs may be added to or removed from the ski, at locations outboard of the center keel for superior directional control, turning and tracking.

The bottom portion of the ski of the present invention is provided with longitudinal dovetail slots, or other configurations or types of retainers that will receive slide in ribs. In addition, the center keel has a sturdy longitudinal T-bar support extending the desired length of the ski, and the keels that are used have T-slots that slide onto the T-bars or supports and then can be latched or retained in place. For example, an end wear bar that will hold the keel in place can be used.

In one form of the invention, a snow diverter or deflector module is placed on the ski to direct snow toward the center of the snowmobile to lubricate the track when the snowmobile is going over hard ground, or places where there is not an adequate covering of snow in the center.

Another aspect is the addition of outer edge slides that extend the width of the ski.

The configuration is such that the base ski and the replaceable modules can be easily molded from suitable durable plastics. The keels, ribs and defectors can easily be inserted and replaced. The ribs and keels can be formed on a full width modular slide that spans the entire bottom of the ski base and is retained as a bottom unit.

Front ski handle retainers are molded in place on the ski, and a molded handle can be removably attached. The handle can be changed as well.

### BRIEF DESCRIPTION OF THE DRAWINGS

FIG. 1 is a side elevational view of a snowmobile ski made according to present invention;

FIG. 2 is a top plan view of the ski of FIG. 1;

FIG. 3 is a sectional view taken generally along line 3-3 in FIG. 2 showing details of a handle mounting;

FIG. 4 is a sectional view taken generally along line 4-4 in FIG. 1 showing the cross-section of the rear portion of the ski;

FIG. 5 is a perspective view of a typical longitudinally extending rib that is removed from the ski;

FIG. 6 is a sectional view taken along the same line as FIG. 4, and showing modifications including side extensions that can be provided on the sides of the ski;

FIG. 7 is a bottom plan view of the ski of FIG. 6;

FIG. 8 is a sectional view taken on substantially the same line as FIG. 4 showing a type of a modular keel installed on the ski;

FIG. 9 is a perspective view of the modular keel shown in cross-section in FIG. 8;

FIG. 10 is a cross-sectional view of the ski illustrating a flexible carbide section keel that is installed on the ski;

FIG. 11 is a side view of the flexible carbide steel keel;

FIG. 12 is a bottom plan view of the ski having a carbide keel insert shown in FIG. 11;

FIG. 13 is a cross sectional view of a ski having a modified keel and ski module;

FIG. 14 is a cross section of the keel and rib module shown on a ski in FIG. 12;

FIG. 15 is a fragmentary cross-sectional view of a ski having an outwardly diverging edge surface to provide a sideward directed spray of snow;

FIG. 16 is a bottom view of the ski portion shown in FIG. 15;

FIG. 17 is a side view of the replaceable ski handle shown in FIGS. 1 and 2;

FIG. 18 is a bottom view of the handle of FIG. 16A;

FIG. 19 is a perspective view of the handle of FIG. 16A; and

FIG. 20 is a sectional view taken on line 20-20 in FIG. 17.

### DETAILED DESCRIPTION OF THE PREFERRED EMBODIMENTS

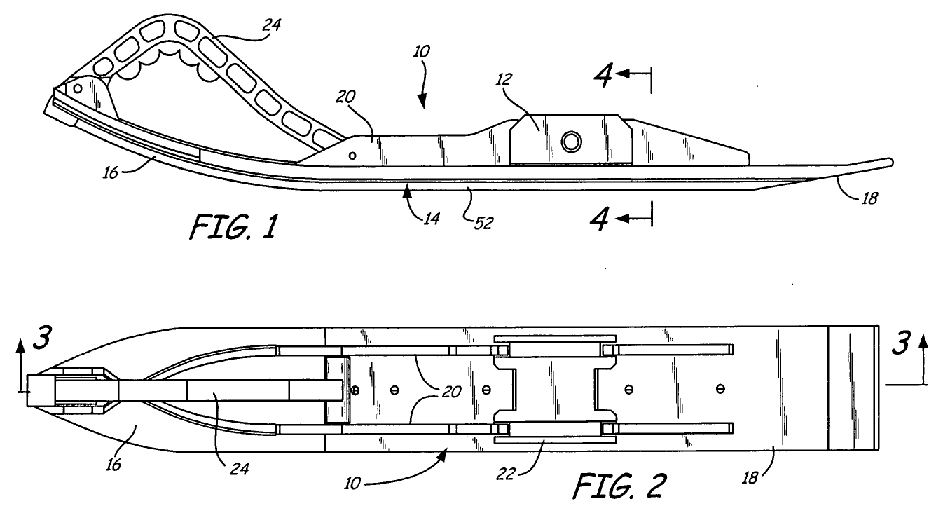

FIGS. 1 and 2 show a snowmobile front steering ski indicated generally at 10 that is provided with an attachment bracket 12 for attaching it to the steering spindles of the snowmobile (not shown). The ski 10 has a base portion 14 that extends longitudinally, with a turned-up tip portion 16, and a tail portion 18. The attachment bracket or mounting bracket 12, as can be seen in FIG. 2, comprises a pair of spaced upright walls 20, on which suitable metal bracket connectors 22 are mounted in a suitable place. Additionally, the tip portion 16 of the ski has a handle 24 attached to the top thereof. The handle 24 is replaceable as will be further explained.

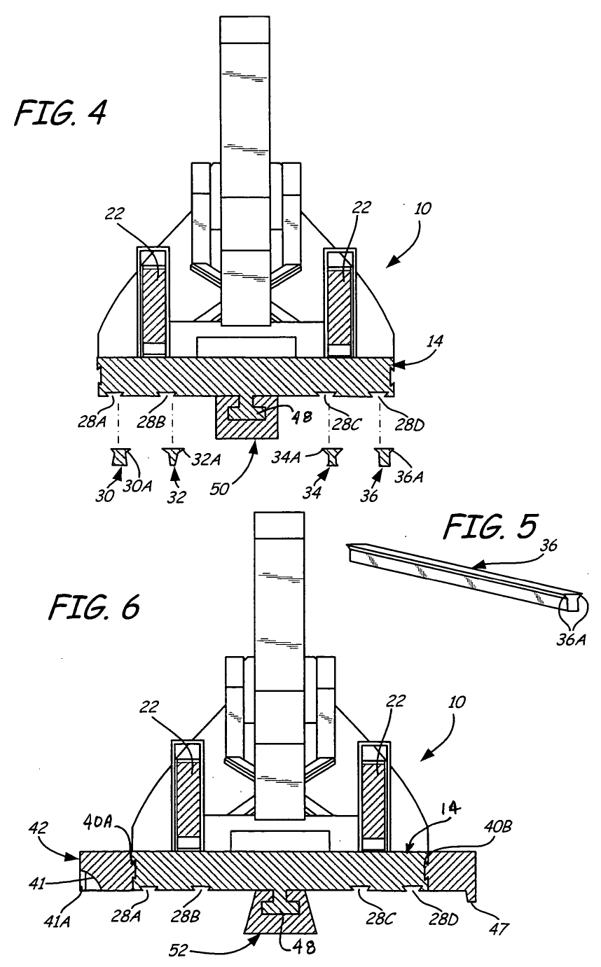

Referring to FIG. 4, it can be seen that base portion 14 of the ski, has a plurality of longitudinal dovetail slots 28A, 28B, 28C, and 28D. The slots 28A-28D extend longitudinally, and are of suitable size for the uses and loads involved. The dovetail slots form first parts of interfitting modular member retainers.

The dovetail slots 28A-28B can be used for retaining slide-in longitudinal traction guide and control ribs. In FIG. 4, which is an exploded view, four different types of longitudinal ribs are shown. These include a trapezoidal cross section rib 30, a triangular cross section rib 32, a rib 34 that has concave or inwardly scalloped sides, and a rectangular cross section rib 36. One or more of these cross sectional shape ribs can be inserted and held in the slots 28A-28D. The ribs on a ski can all be the same shape, or can be more than one shape, depending on the desired results. For example, it may be desirable to have the trapezoidal shaped ribs 30 attached through the outer grooves 28A and 28D, and the triangular shaped ribs 32 attached through the inner grooves 28B and 28C. If desired, one of the other cross section shape ribs could be placed in the inner grooves. The dovetail flanges on the ribs form second parts of the interfitting modular member retainers.

FIG. 5 shows a full length view of the rectangular cross-section rib 36, and it can be seen that the dovetail slide tops of all of the ribs have dovetail flanges illustrated generally with an “A” designation after the rib number. For example, the dovetail flanges 36A are on the rib 36, dovetail flanges 34A are on the rib 34, and dovetail flanges 30A and 32A are on the ribs 30 and 32, respectively. These dovetail flanges are shaped and sized to slide into the dovetail slots 28A-28D. The longitudinal ribs can be latched or locked in place in any desired manner including set screws, pins or the like, or by merely placing removable blocks at the ends of the dovetail slots to block longitudinal movement or sliding of the ribs along the slots. The ribs are installed by sliding them along the dovetail slots.

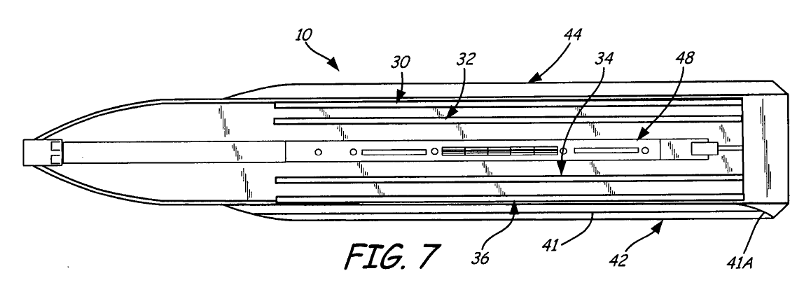

FIG. 6 shows a modified base 14A of a ski, and in this case, base 14A has the dovetail slots 28A-28D as before, but it also has longitudinal dovetail slots 40A and 40B that are formed on the side edge surfaces of the ski. This permits an elongated longitudinal side or width extension flange 42 to be placed into the dovetail slot 40A, and held in place in a suitable manner so that it would have an appearance from the bottom that is shown in FIG. 7.

As a variation of construction, a concave, rounded or part cylindrical recess 41 is formed at the lower side edge of the side extension 42. The concave recess 41 extends the length of the ski. As shown in FIG. 7, a snow diverter surface 41A at the rear portion of the concave recess concave slot 41 tapers laterally outwardly to spray snow toward the center of the snowmobile on which the ski is mounted. The snow spray is to help provide track slide lubrication. The snow diverter surface 41A provides a spray right onto the track and track slide of the snowmobile (not shown).

The dovetail slot 40B on the opposite side of the ski base 14A has an elongated longitudinal side extension 44 installed and held in dovetail slot 40B. The side extension 44 also includes a depending edge rib 47 along the outer side thereof, to provide for additional control. The surface of the rib 47 also can have an outwardly tapered rear end surface to provide a snow spray toward the track if the rib is on a side of the ski adjacent the track.

As shown in FIG. 7 in the bottom view, the side extensions 42 and 44 extend forwardly to where the ski tip starts to curve upwardly, and extend all the way to the rear end. The rear ends of the side extension can be tapered or cut as shown for smoothness or streamlining.

The bottom view of FIG. 7 also shows longitudinal ribs 30, 32, 34 and 36 in the slots 28A-28D. The ribs can be any desired cross-sectional shape, in addition to the shapes previously specifically discussed.

In addition to the dovetail slots, the ski base 14, and also the ski base 14A, are provided with a T-shaped longitudinally extending protruding support 48, in the center or keel region of the ski. The T-shaped support 48 forms a first part of an interfitting modular member retainer. The T-shaped support 48 is shown in FIG. 4 with a rectangular cross-sectional keel 50 slid into place. In FIG. 6, the T-shaped support 48 is shown with a trapezoidal keel 52, which is shown in cross-section with sharper corners at the bottom side edges to be more aggressive and helping to keep the ski from sliding sideways. The ribs and the keel sections can all be molded from a suitable plastic or other synthetic material, and can be brightly colored if desired.

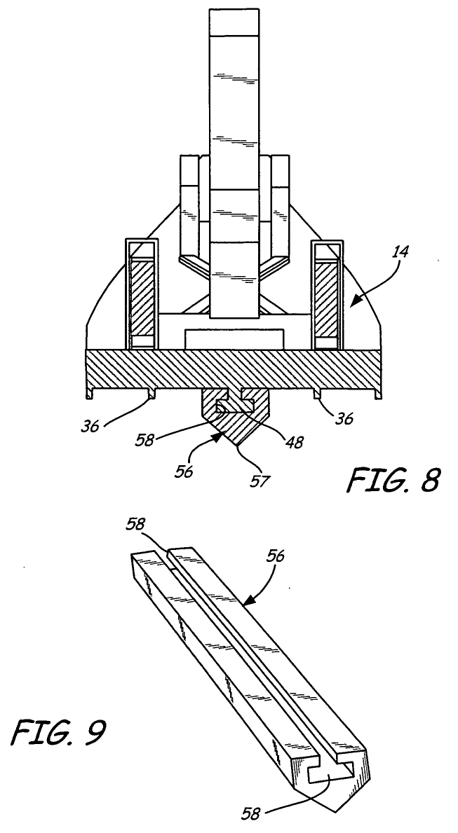

FIGS. 8 and 9 show a further modified keel 56 in position. The keel 56 has a triangular cross section bottom portion with a longitudinal edge 57. The keel 56 has a T-shaped slot 58 that slides over the T-shaped support 48 as shown. FIG. 9 shows the length of the triangular keel 56, for illustrative purposes, with the slot 58. The slot 58 has an opening along its length and can be slid onto the T-shaped support 48. T-shaped supports and slots can also be provided for holding ribs instead of the dovetail slots and flanges, if desired. The T-shaped slots that slide onto the T-shaped supports form second parts of interfitting modular member retainers that are T-shaped.

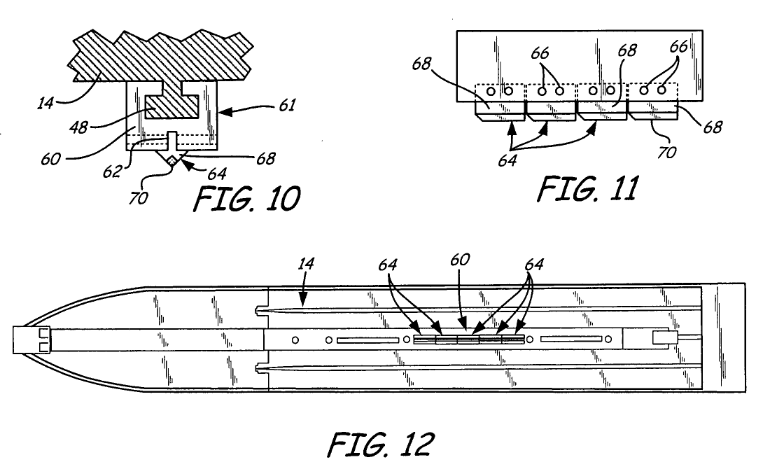

FIGS. 10, 11 and 12, show a base 14 of a snowmobile ski with a sectional, longitudinally flexible carbide keel 60 in position. The carbide keel 60 has a body 61 that has a T-shaped slot that slides over the T-shaped support 48. The body 61 also has a lower longitudinally extending slot 62 in which carbide steel segments 64 are positioned and held with suitable fasteners 66 or held in other ways. The carbide steel segments 64 form runners that are embedded into and held by a support or frame 68, and held in place. The supports or frames 68 are formed as short sections, so that the body or support housing 61 can flex slightly when the ski flexes without breaking the carbide inserts. Also as can be seen, the carbide inserts have sharpened lower edges 70 for gripping ice and hard surfaces.

FIG. 12 is a bottom view of the ski 14 that shows the carbide keel 60 in position, with the individual steel segments 64 shown. The carbide sections 64 protrude from the body 61 along a short portion of the length of the ski. The number of carbide keel sections 60 can be varied, as desired.

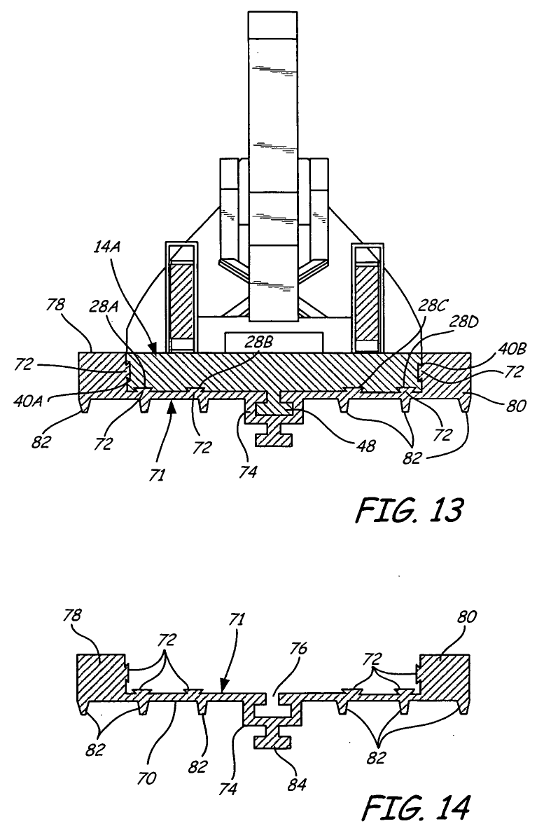

In FIGS. 13 and 14, a unitary bottom rib and keel wear base or plate attachment 71 that can be slid onto a base 14A is shown. The wear base attachment 71 can be provided with keel structures, ribs, and/or also side extensions as illustrated. The ski base 14A, which has the bottom dovetail slots as shown in FIG. 6, and also slots along the side edges, is used for mounting the molded modular wear base attachment 71, and as can be seen, the wear base attachment has dovetail slides 72 that will fit into the dovetail grooves 28A-28D as well as side slides 72 that slide into the side grooves 40A and 40B. In addition, the keel wear base 71 has a center keel section 74 with a T-shaped slot 76 that will slide over the T-shaped support 48 on the base 14A.

The keel wear base or plate 71 includes ski side extensions 78 and 80. The wear base or plate 71 can be slid into the dovetail slots of the base 14A and along the T-shaped support 48, so that the assembly is made as shown in FIG. 13. FIG. 14 shows the modular keel wear base 71 separately. Ribs 82 extend downwardly from the lower surface of the keel wear base 71.

A T-shaped rib or support 84 is provided in the center of the keel wear base for receiving keel members that have slots that slide on the T-shaped support 48. The keel members would be held in place as discussed previously.

A single molded replacement modular keel wear base can be slid into place on a ski base. The modular keel wear base can have molded in ribs and side extensions. The keel wear base 71 includes a support 84 for adding a keel member in the center. The modular keel wear base will slide easily onto a ski base 14A so that the user can change the entire base configuration at once as a modular unit, if desired.

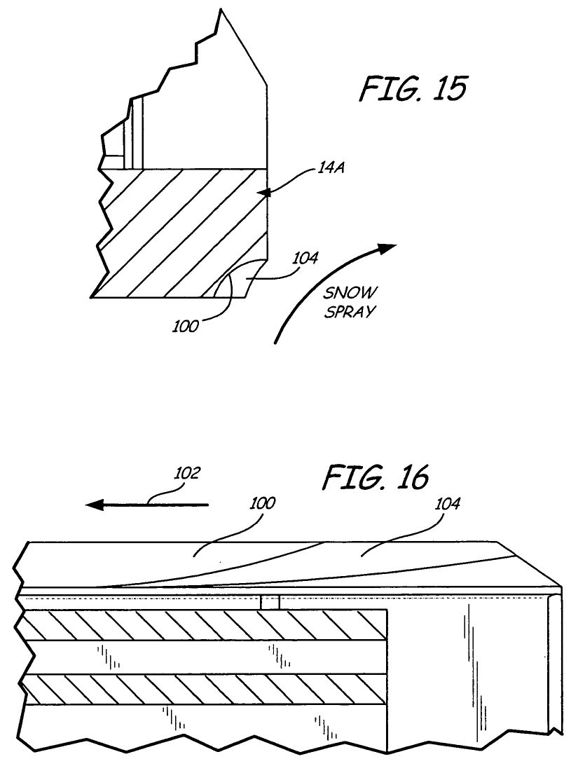

FIGS. 15 and 16 show the concave snow spray diverter surface on a ski base 14A without side extensions. The ski base 14A has a longitudinal part cylindrical concave surface or recess 100 that will rest on snow as the ski moves forwardly in the direction shown by arrow 102 in FIG. 16. The surface 100 joins an outwardly tapered, concave surface section 104 at the rear of the ski base 14A. This sprays snow toward the track slide to help in lubricating the track.

Other laterally outwardly tapered surface shapes can be used. For example, a rear portion of one of the ribs can incline toward the center. A side surface of one of the ribs can be inclined. The inclined surface should be near or at the inside edge of the ski.

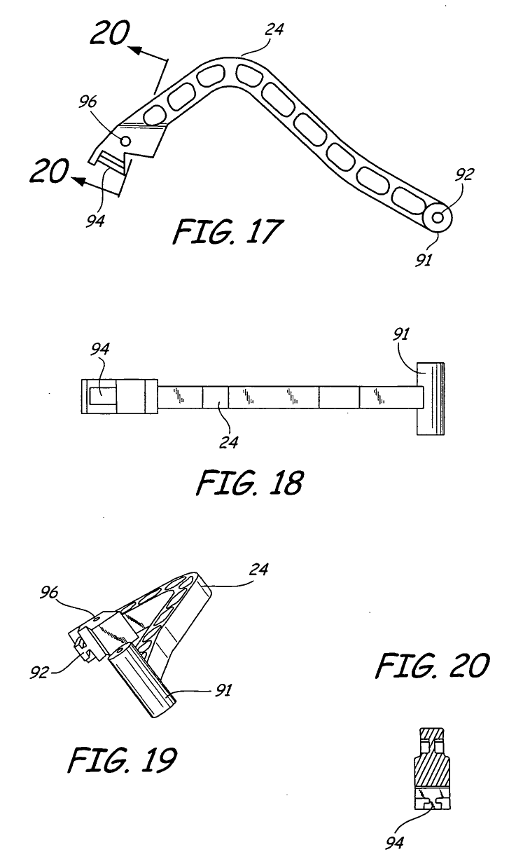

In FIGS. 17-20, the handle 24 is illustrated. The handle 24 is shown removed from the snowmobile ski, and it can be seen that it is curved in an arch, with a pin receiving hole 92 at one end, so it can be pinned to ski brackets, and a type of a T-shaped retaining lug 94 at its other end that can be slid into a slot on the tip of the ski. The handle 24 can be easily replaced and held in position. A lock pin hole 96 is provided to receive a pin to lock the handle 24 in place. Replacement of the retainer pins can be done easily, and the handle 24 will slip into place with the T-shaped retainer 94. Then the hub 91 that has the hole or bore 92 will be put into the place and the retainer pins then passed through the brackets on the ski to hold the handle 24. The handle 24 can thus be replaced easily as a modular component.

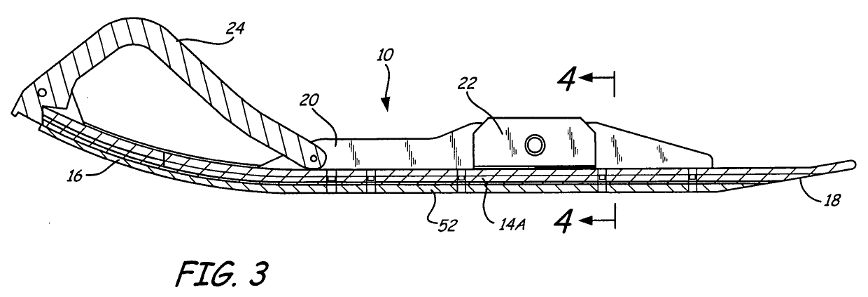

The center keel shown can extend all the way forwardly to where the handle fastens in place, and the handle 24 can form a stop to prevent the keel from being removed. This is generally shown at FIG. 3, where the handle is in cross-section.

The skis can be for snowmobiles as described, or for other power vehicles used in snow, such as all terrain vehicles adapted for snow use.

Although the present invention has been described with reference to preferred embodiments, workers skilled in the art will recognize that changes may be made in form and detail without departing from the spirit and scope of the invention.

What is claimed is:

1. A modular power vehicle ski having a base that has a longitudinal length and a bottom, a first part of an interfitting retainer formed on the bottom, a modular elongated member having a second part of the interfitting retainer, the modular member having a cross-sectional shape for engaging a surface on which the ski is moving, the first and second interfitting retainers holding the modular elongated member in place on the ski during use.

2. The modular ski of claim 1, wherein the modular elongated member has a rib that depends from the bottom of the ski.

3. The modular ski of claim 1, wherein the first part of the interfitting retainer comprises recesses in the bottom of the ski to hold a mating second part of the interfitting retainer on one or more of the modular members.

4. The modular ski of claim 1, wherein the modular elongated member comprises a center keel portion having the second part of the retainer, the first part of the interfitting retainer receiving interfitting the second part of the retainer to hold the modular elongated member on the bottom of the ski.

5. The modular ski of claim 4, wherein said center keel portion has carbide inserts on a bottom edge thereof.

6. The modular ski of claim 1, wherein the interfitting retainer parts comprise a plurality of slots and a plurality of modular members comprising ribs having flanges that fit in the slots so that a plurality of the ribs are mountable on a bottom of the one ski.

7. The modular ski of claim 1 further comprising at least one longitudinal edge having a first part of a second interfitting retainer formed in the edge of the base and a second modular elongated member having a second part of the second interfitting retainer wherein the second modular member has a downwardly extending longitudinal edge.

8. The modular ski of claim 1 and further comprising a snow diverting surface disposed on an edge of the ski, the snow diverting surface extending from an outer edge surface and extending inwardly towards a center of the ski for diverting snow.

9. The modular ski of claim 1 further including a longitudinally disposed concave surface extending along an edge of the ski, a snow diverting surface being disposed at a rearward position within the concave surface.

10. A modular power vehicle ski comprising:
a base having a length and a bottom longitudinal surface;
a detachably attached wear plate having an upper surface and a bottom surface with a first part of an interfitting retainer formed on the bottom surface and the upper surface engaging the base;
a modular elongated member having a second part of the interfitting retainer, the modular member having a cross-sectional shape for engaging a surface on which the ski is moving; and
wherein the first and second interfitting retainers hold the modular elongated member in place in the ski during use.

11. The modular ski of claim 10 further comprising at least one longitudinal edge having a first part of a second interfitting retainer formed in the edge of the base and a second modular elongated member having a second part of the second interfitting retainer wherein the second modular member has a downwardly extending longitudinal edge.

12. The modular ski of claim 10 and further comprising a snow diverting surface disposed on an edge of the ski, the snow diverting surface extending from an outer edge surface and extending inwardly towards a center of the ski for diverting snow.

13. The modular ski of claim 10 further including a longitudinally disposed concave surface extending along an edge of the ski, a snow diverting surface being disposed at a rearward position within the concave surface.
